(19) United States
(12) Patent Application Publication
(10) Pub. No.: US 2011/0110416 A1
(43) Pub. Date: May 12, 2011

(54) Video Codec System and Method

(75) Inventor: James Lawrence, Henderson, NV (US)

(73) Assignee: BALLY GAMING, INC., Las Vegas, NV (US)

(21) Appl. No.: 12/617,674

(22) Filed: Nov. 12, 2009

(51) Int. Cl. H04N 7/12

(52) U.S. Cl. 375/240.01; 375/E07.076

(57) ABSTRACT

Various embodiments disclosed herein are directed to a video codec engine system for a gaming machine. The system includes: an encoder and decoder system for encoding and decoding video and still images, wherein the encoder and decoder system includes a library to encode to blob and decode from blob, wherein blob is a binary large object comprising a large image or sound file, and a partial decoding component, wherein the partial decoding component supports decoding a sub-rectangle of a given frame. The encoder and decoder system breaks up an image into spatial blocks, choosing an encoding type for each block from a list of possible encoding schemas. The schemas are individually designed such that decoding procedures are a series of repetitive operations on byte-aligned symbols in a fixed length data stream. The video codec engine system enables a seek function that advances in stream without decoding all frames in-between a beginning seek frame and an ending seek frame. The video codec engine system enables alpha blending of its output buffer with an output from another buffer. The system supports both still frames and video.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

This disclosure relates generally to a gaming system and, more particularly, to a system and methodology for providing an enhanced video codec engine.

### BACKGROUND

Video can use a large amount of memory in gaming applications. In this regard, newer and more advanced video technologies can require even larger amount of memory. Such large memory requirements can dramatically increase overall costs and efficiency. These levels of memory requirement are not practical for mainstream use. BINK is a proprietary video file format (extension .bik) developed by RAD Game Tools that is primarily in computer games. The format includes its own video and audio codecs. BINK supports resolutions from 320×240 to high definition (HD) video.

Currently, video engines in use by Alpha products support MNG (Multiple-image Network Graphics), FLC, and BINK formats for files on disk. After the gaming machine boots, the disk file is ignored and only in-memory RAM is used. In other words, only in-memory formats are used to control the content that a player sees. Realistically, the only in-memory formats currently supported are BINK, FLC, and an untitled in-house format, called Alpha RLE, still the MNG format is too slow for practical use, hence it is never supported. FLC has proven unpopular with game development. BINK is a viable alternative, but has areas for improvement.

The Alpha RLE format is a run-length codec. Generally, Alpha RLE does about half as well as PNG (Portable Network Graphics), which is a bitmap (raster) graphic file format. Alpha RLE cannot support 24-bit effectively. Furthermore, Alpha RLE is not lossless and it adds considerably to boot time of a gaming machine since no file support exists for the format. Nevertheless, Alpha RLE is fast with respect to playback during game play.

While BINK is good codec that compresses to very low bit-rate, it is not lossless. Its other weaknesses include: (1) BINK does not support partial decoding. Thus, if a background image is partially occluded by a front image, the entire background image must be decoded. The compression algorithm requires decoding the entire image because the image is partially differentially encoded from itself. (2) BINK encoding/decoding is done in software, not hardware, requiring CPU cycles to process. (3) BINK decoding CPU utilization may be high, depending on the application. (4) When using BINK, Alpha blending is difficult to completely optimize since the decoding, and a blending cannot be the same loop due to API boundaries. (5) Simplistic content as buttons is not recommended for BINK. For example, an all-black background does not need to be encoded as a BINK since a complex algorithm is not required to deal with it efficiently. In addition, sequences of images that are random-access may not be beneficial since a random access seek in BINK can be expensive due to differential encoding. (6) Like any DCT/wavelet-based codec, BINK shows difficulty with content with sharp edges and changing scenes. The content is predictively encoded and rapid changes are atypical predictions. Hence, these types of clips require a higher bit-rate and take more time to process decoding on the gaming machine.

Another alternative solution that exists is MPEG. MPEG-4 minimally is required, as MPEG-2 does not support the Alpha channel. However, MPEG-4 requires considerably higher CPU usage than BINK. NVIDIA cards partially support MPEG-4 in decoding in hardware. However, decoding as a part-software/part-hardware solution in the board only supports doing the algorithm's basic building blocks in hardware. The texture download to the device and associated software component complexity would roughly equal BINK in speed. Importantly though, the manufacturer has not yet provided Linux drivers for MPEG-4 decoding by NVIDIA hardware, leaving it moot for now.

Accordingly, it would be desirable to use more advanced video technologies with the same or lower memory requirements as a legacy server.

### SUMMARY

Briefly, and in general terms, various embodiments are directed to a video codec engine system for a gaming machine. The system includes an encoder and decoder system for encoding and decoding video and still images. Preferably, the encoder and decoder system includes a library to encode to blob and decode from blob, wherein blob is a binary large object comprising a large image or sound file. The encoder and decoder system breaks up an image into spatial blocks, choosing an encoding type for each block from a list of possible encoding schemas. The schemas are individually designed such that decoding procedures are a series of repetitive operations on byte-aligned symbols in a fixed length data stream. The system further includes a partial decoding component that supports decoding a sub-rectangle of a given frame. The video codec engine system enables a seek function that advances in stream without decoding all frames in-between a beginning seek frame and an ending seek frame. Additionally, the video codec engine system enables alpha blending of its output buffer with an output from another buffer. The system also supports both still frames and video.

In one embodiment, the system is configured to operate on items that are byte-aligned, are repetitive in nature, and have a predetermined fixed data length. Preferably, the system includes a list of possible encoding schema for each spatial block with schemas that specifically target byte-aligned methods. In another aspect, the system employs lossy video as a pre-filter to encoding only, while decoder code is the same for lossless and lossy video. In still another aspect, the system employs pixel correlation such that the system breaks images into N by N blocks when compressing patterns to take advantage of spatial redundancy. In another embodiment, the encoder and decoder system enables several different block types, including null, run, fixed, prediction, hierarchical, adaptive, and pattern block types.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 illustrates a block diagram of the components of a gaming device.

FIG. 2 illustrates one embodiment of a gaming device including the secured module for validating the BIOS.

FIG. 3 illustrates one embodiment of a gaming system network including the gaming devices of FIG. 2.

### DETAILED DESCRIPTION

Various embodiments disclosed herein are directed to gaming devices having a system and method for implementing an Iris video codec engine system that provides a fast, high-quality, low-bit-rate codec optimized for gaming machine level requirements. Traditionally, codecs for movie and still content are made to broad international standards that must comply with the needs of the international community for moving pictures. In a gaming environment however, there are specific requirements with respect to codecs for movie and still content. Specifically, in a gaming environment the quality must be very high, the content is “cartoonish” in nature, and the decoder must be extremely light on the CPU usage. Additionally, certain restrictions that are higher for broad international standards, are less restrictive and more flexible in a gaming environment. For example, an encoder does not need to perform in real-time, the size of executable memory may be negligible, and the compression ratios achieved are not more important than the speed of the decoder.

In a preferred embodiment, the Iris video codec engine system is configured to provide fast decoding, which is top priority in a gaming environment, since these types of games display a large amount of content simultaneously. Preferably, the Iris video codec engine system alleviates a need for specialized hardware to decode content, which is prohibitive due to the considerable cost to the game platform's hardware. In one embodiment, the Iris video codec engine system yields comparable or better compressions than existing video compression technologies by removing unnecessary and cumbersome features such as real-time encoding. Moreover, the Iris video codec engine system may be embodied in hardware for some embodiments.

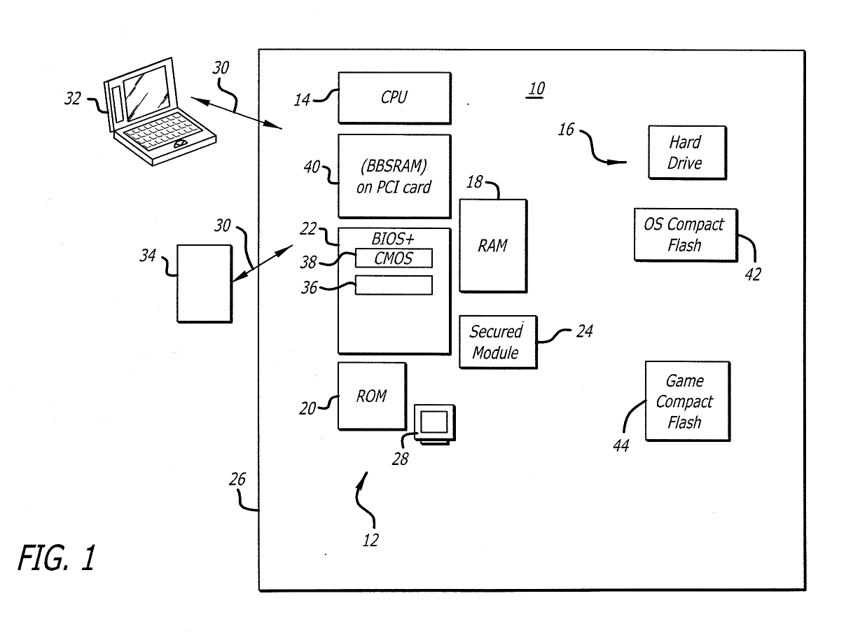

In one preferred embodiment, the Iris video codec engine system is designed to construct low-bitrate streams that facilitate fast decoder code. The codec breaks up the image into spatial blocks, choosing an encoding type for that block from a list of possible encoding schemas. The schemas are individually designed so decoding procedures are a series of repetitive operations on byte-aligned symbols in a fixed length data stream. The spatial-block/list concept provides low-bitrate streams, while the repetitive, byte-aligned, fixed length nature of the stream provides speed. Preferably, the Iris video codec engine system contains a list of possible encoding schema for each spatial block, with those schemas specifically targeting byte-aligned methods since they are computationally inexpensive. In another aspect, the Iris video codec engine system is unique in its application of “lossy” video as a pre-filter to encoding only, with the decoder code being exactly the same for lossless and “lossy” video. Referring now to the drawings, wherein like reference numerals denote like or corresponding parts throughout the drawings and, more particularly to FIGS. 1-3, there are shown various embodiments of a gaming system employing an Iris video codec engine system.

FIG. 1 illustrates a block diagram of the components 12 of a gaming device 10. The components 12 comprise, for example, and not by way of limitation, software or data file components, firmware components, hardware components, or structural components of the gaming machine 10. These components include, without limitation, one or more processors 14, a hard disk device 16, volatile storage media such as random access memories (RAMs) 18, read-only memories (ROMs) 20, or electrically-erasable, programmable ROMs (EEPROMS), such as basic input/output systems (BIOS) 22. Additionally, the gaming device 10 includes a secured module 24. The secured module is a hardware component that is one-time programmable. One or more security algorithms may be provided on the secured module. The security algorithm generates a challenge (e.g., generates a random number), calculates an expected response to the challenge, and determines the validity of the BIOS, based on the response to the challenge provided by the BIOS. In one embodiment, the secured module is a field-programmable gate array (FPGA). In another embodiment, the secured module is a trusted platform module (TPM).

In one embodiment, components 12 also include data files (which are any collections of data, including executable programs in binary or script form, and the information those programs operate upon), gaming machine cabinets (housings) 26, displays 28, or compact disk read-only memory (CDROM) or CD read-write (CR-RW) storage. In one embodiment, the data files may include data storage files, software program files, operating system files, and file allocation tables or structures. Ports 30 are TO be included with the gaming machine 10 for connection to diagnostic systems 32 and other input/output devices 34. In one embodiment, the ports 30 each comprise a serial port, universal serial bus (USB) port, parallel port or any other type of known port, including a wireless port. Preferably, each of the components 12 have embedded or loaded in them identification numbers or strings that can be accessed by the processor 14, including the processor itself, which are utilized for authentication as explained below. In ONE embodiment, the components that are data files each use their file path and name as their identification number or string.

Either within the gaming machine 10, or in the diagnostic system 32 attachable to the gaming machine 10, are executable instructions or a software program 36 for authentication of the components (authentication software 36), which itself may be one of the components 12 to authenticate if it is internal to the gaming machine 10. In one embodiment, authentication software 36 is stored on a persistent storage media such as the hard disk device 16, ROM 20, EEPROM, in a complementary metal oxide semiconductor memory (CMOS) 38, in safe rRAM comprising a battery-backed static random access memory (BBSRAM) 40, in flash memory components 42, 44, or other type of persistent memory. In one embodiment, the authentication software 36 is stored in a basic input/output system (BIOS) 22 device or chip. BIOS chips 22 have been used for storing prior authentication software, such as previous versions of the BIOS+ chip used by Bally Gaming Systems, Inc. of Las Vegas, Nev. in their EVO gaming system. Placing the authentication software 36 in the BIOS 22 is advantageous because the code in the BIOS 22 is usually the first code executed upon boot or start-up of the gaming machine 10, making it hard to bypass the authentication process. Alternatively, in one embodiment, the authentication software 36 is stored in a firmware hub (FWH), such as Intel's 82802 FWH.

As an alternative, instead of, or in conjunction with, the hard disk device, another mass storage device is used, such as a CD-ROM, CD-RW device, a WORM device, a floppy disk device, a removable type of hard disk device, a ZIP disk device, a JAZZ disk device, a DVD device, a removable flash memory device, or a hard card type of hard disk device.

It should be noted that the term gaming device is intended to encompass any type of gaming machine, including hand-held devices used as gaming machines such as cellular-based devices (e.g., phones), PDAs, or the like. The gaming device can be represented by any network node that can implement a game and is not limited to cabinet based machines. The system has equal applicability to gaming machines implemented as part of video gaming consoles, handheld, or other portable devices. In one embodiment, a geo-location device in the handheld or portable gaming device may be used to locate a specific player for regulatory and other purposes. Geo-location techniques that can be used include by way of example, and not by way of limitation, IP address lookup, GPS, cell phone tower location, cell ID, known Wireless Access Point location, Wi-Fi connection use, phone number, physical wire or port on client device, or by middle tier or backend server accessed. In one embodiment, GPS and biometric devices are built within a player's client device, which in one embodiment, comprises a player's own personal computing device, or provided by the casino as an add-on device using USB, Bluetooth, IRDA, serial or an other interface to the hardware to enable jurisdictionally compliant gaming, ensuring the location of play and the identity of the player. In another embodiment, the casino provides an entire personal computing device with these devices built in, such as a tablet-type computing device, PDA, cell phone or other type of computing device capable of playing system games.

In one implementation of the Iris video codec engine system, the functionality of the system includes: (1) support for encoding and decoding; (2) support for partial decoding (e.g., the codec supports decoding a sub-rectangle of a given frame); (3) support for seek functions (i.e., advancing in stream without decoding everything in-between); (4) support for integrated Alpha blending (e.g., the codec supports alpha blending its output with another buffer; and (5) support for both stills and movies.

In an embodiment of the Iris video codec engine system, no new or specialized hardware is required. The system is designed for low memory, low CPU embedded environments. In another aspect of the Iris video codec engine system, no systems layers are required and no audio encapsulation is required. In this regard, future libraries may have all multimedia content of a game embedded into a single file. Continuing, in another aspect of the Iris video codec engine system, no game API (application program interface) changes are required.

In one embodiment, the Iris video codec engine system includes an encoder, editor, a player, and a plug-in. The Iris codec encoder is a Windows and Linux tool that converts from common movie and still formats to the Iris format. The Iris codec editor is a Windows and Linux tool that performs basic cut and paste edit operations. The Iris codec player is a standalone Windows and Linux player that performs basic VCR playback-type functions. Finally, the Iris codec plug-in is a “plug-in” application tool for use with common artist studios.

A preferred embodiment of the Iris video codec engine system reduces the redundancy of input to a small output data stream, and is a fast software decoder first, with a low bit-rate being important, but secondary. In video graphics in the gaming environment, the degree of correlation between a pixel and the pixel to its lower right is higher than the one right before it or right after. Otherwise stated, pictures typically repeat the same color in the vertical and diagonal direction, not just the horizontal. The Iris video codec engine system breaks images into N×N blocks when compressing patterns to take advantage of spatial redundancy.

In another aspect of one embodiment, the Iris video codec engine system utilizes a byte-aligned approach. Performance issues of MNG, BINK, Smacker, HuffYuv and Huffman/Entropy based codec are in large part due to the fact each output symbol is not aligned on a byte boundary. The “bit stream” concept causes the decoder to do masking, shifting, and position tracking, which are expensive. The Iris video codec engine system sets a priority to output symbols that are byte-aligned. The byte-aligned approach enables simple, fast decoding, for example, using an index to an array. This approach also lends itself well to MMX instructions, which are designed for operating on items on a byte-boundary. In addition, the byte-aligning enables a hard-coded unrolled loop to be used since no “if” controls the logic flow of advancing the current position in the decoders bit input stream. A block-based approach may be used to assist this goal since the block is a well known size before the decoding begins.

In another aspect, the Iris video codec engine system avoids transformations that involve a loss of quality (i.e., “lossy operations”). Since any perceptible loss of quality is considered unacceptable, usages of available cycles for such transformation are considered unworthy. Profiling MPEG and BINK style codec for decoding of pictures shows transformation for DCT/Wavelet and conversion from RGB color space to the YUV color space as the highest percentage of time among decoding operations.

In another embodiment, the Iris video codec engine system supports a mode in which a block of information is considered the same as a previous block using a simple lossy technique of applying a threshold, called a “sieve.” This lossy method may be employed since the decoder speed is completely unaffected, with the sieve filter done entirely by the encoder. This lossy method takes advantage of the fact that a block of information that is the same as the previous block runs orders faster than a block with just a single different value. Just having a single different value in the block sets the processing time to a relatively high baseline compared to no processing required at all when the block is the same as the previous block. Additionally, the lossy mode for the encoder is extended with color reduction. When in the lossy mode, the encoder runs a settable amount of color reduction, capped at an unnoticeable change from the input data. The decoder is again unchanged.

In another aspect of one embodiment, the Iris video codec engine system is configured to employ customized schemas. Given a stream of data, a scheme to encode a particular stream made by hand will always outperform a general schema. In other words, a customized solution to encode a particular content (e.g., made by hand) usually outperforms a generalized one. Therefore, the Iris video codec engine system does not attempt to define one solution to fit all. Since encoding time is mostly irrelevant in making games, the Iris video codec engine system compresses each block (not each frame) using a lengthy variety of methods. The method that compresses to the lowest bit-rate is the one typically chosen for output, however, performance factors of various schemas can affect this decision.

In still another aspect of one embodiment, the Iris video codec engine system is built for cartoonish content, which typically has a high-degree of correlation in local neighborhoods. Also, usually the total number of unique colors is local neighborhoods is rather modest. The Iris video codec engine system compresses blocks with a “palette,” which is a look-up table of a possible number of colors for each block. Additionally, the Iris video codec engine system supports “floating” palettes, which are differences from the last palette, which typically do not change much. The palettes are then compressed by referring to a global palette, which contain all bits of the color, with the local palettes indexed to the global table. The purpose of the local palette is to reduce the number of required bits to identify a symbol. The global palette is sorted by frequency of occurrence of a symbol to increase the likelihood of indexes small size numbers, i.e., few bits. The palette processing for the decoder of the system, if chosen by the encoder for output, is only done each 64 pixels, a small portion of simple computation. The pixel decoding is done such that the palette indexing only adds a single step of a single index operation (if not part of a run, which is often).

In yet another embodiment, the Iris video codec engine system supports encoding the difference of the current frame from the previous frame since the compression gains from the simple technique are high. The difference block is another block type.

Lossy techniques such as MPEG and BINK require processing cycles of the decoder to restore a quantized value to its original. Since any perceptible loss of quality is considered unacceptable, usages of available cycles for such transformation are considered unworthy. However, the Iris video codec engine system supports a lossy mode that requires no change whatsoever to the decoder. While in lossy mode, the maximum possible loss is settable, with a default at 0.5%, although typically though the error is much less. Since the lossy mode decreases the output of data to process, this actually helps the speed. The lossy mode typically implements a custom made color reduction filter, which reduces the number of unique colors in the image. Also, the lossy mode considers the current block to be the same as the previous frame's block, if the difference is under a given threshold. Both have a multiplicative effect on speed and compression.

Unlike the Iris video codec engine system, most codecs for video, especially lossy video, utilize a transformation such as DCT/Wavelet and a conversion from RGB color space to the YUV color space. The profiling of the codecs such as BINK and MPEG show the highest percentage of time for decoding frames is spent in the transform (DCT or Wavelet) and RGB-to-YUV colorspace conversions. Since the Iris video codec engine system does not use these operations, the system does not have their associated limitations.

In one preferred, non-limiting embodiment, the Iris video codec engine system breaks images into 8×8 blocks to take advantage of spatial redundancy. Blocks are dealt with at higher levels of code as N×N, by default eight, chosen as a well-known good value for block size in the industry. The non-integral columns and rows (e.g., for an image size 243×131 instead of 256×240) may be dealt with using the hierarchical block type to divide the block into sub-blocks of smaller size. So the non-integral data (columns and rows) are removed from the process intensive parts of the block-decoding loop (the pixels) by the encoder. In this manner, the encoder encodes the non-integral rows and columns by extending the images to be evenly divisible by 8 boundaries. Thus, is one example, the last value in a line is simply repeated. Since these are runs, they encode well. Preferably, the non-integral data is never copied from the block-decoding buffer to the output data buffer.

As referred to herein, a “method” is one possible combination of block types, block schemas, and block options. A local palette is an example of one method. A method must use output storage to identify itself to the decoder. In this manner, choosing the set of methods to use is important to low output bit-rate. Furthermore, the encoding of blocks may be optimized by using a number of unique colors needed and the current size of the best method that has been identified to encode. For example, a block having three unique colors cannot be done with a one bit schema. Also, a prediction block requires at least eight bytes, so a best method tried with five bytes is the clear winner over prediction with no try needed.

In one embodiment of the Iris video codec engine system palettes may be differentially encoded, using the following header:

| Bits | Field |
|---|---|
| 2 | Format |
| 6 | Number of Palette Entries (N) |
| 4 | Palette Entry Size (B) |
| N*B | Palette Data |

Preferably, the local palette enables for data to be stored without using the global palette. The format header allows for future formats, such as differentially encoding the local palette.

In another embodiment of the Iris video codec engine system, palettes may be differentially encoded, using the following header:

| Bits | Field |
|---|---|
| 2 | Format |
| 6 | Number of New Palette Entries (N) |
| 6 | Number of Removed Palette Entries (N) |
| 4 | Palette Entry Size (B) |
| N*B | Palette Data |

Preferably, the local palette is used to represent certain methods of encoding cases. For example, a color at index three in a global palette would not be able to be encoded at one bit per pixel without using a local palette. However, it may be encoded raw with using run length or prediction block types.

In another aspect of the Iris video codec engine system, inverted data indicates that the data is inverted with positions of (x, y) inverted to (y, x). If the data is highly correlated in the vertical direction, the inverted option is useful. Such implementation may either use (1) a “ZigZag” array that adds an additional index to decide the target location pixel decodes or (2) optimized code that hard codes the locations if the block is of a fixed size. If differential data is produced, this indicates the encoding method is the same as the previous block. If a palette is not used, the data contains additive values for R, G, and B in packed, not planar format. Alternatively, if a palette is used, value 0 indicates to the previous block value, with other values used in same way as non-inter blocks.

Block types, options, and schemas are described herein with respect to their uses in Iris video codec engine system. The video engine system converts from input format to a chosen block type given below. The byte header preceding block data indicates the method, and “N” is eight by default.

In one embodiment, the block options include local palettes, inverted data, and differential. If local palettes are used, the block includes a local palette option utilizing a global palette. If inverted data is used, then the data is encoded in vertical, not horizontal direction. If differential is used, then 0 is encoded for the previous frame's value, otherwise the value 1.

In another aspect of the Iris video codec engine system, block types and their associated schemas include: null, run, fixed, prediction, hierarchical, adaptive, and pattern. The null block is either all the same color, all zero, or the previous block. If the null block is all the same color, the color comes after the header. For all other schemas, the block is the header only, with no data.

The run block type consists of a one byte symbol of {color, run} used for a whole block (e.g., {two bits color, six bits run}, {three bits color, five bits run}, and the like) which are all byte-aligned. Further, the run block type is a variable stream of nodes that are one byte or two bytes in little-endian format. Little-endian is a term that describes the order in which a sequence of bytes are stored in computer memory. Little-endian is an order in which the “little end” (least significant value in the sequence) is stored first. This provides for a fast typecast on x86 architectures. Each node consists of two symbols having length {C, R} where C is the number of bits indicating the color and R is the number of bits for the Run. The Run is non-zero. Possible schemas include:

1 byte: {2, 2}, {2, 6}, {3, 1}, {3, 5}, {6, 2}

2 byte: {2, 14}, {3, 13}, {4, 12}, {5, 11}, {6, 10}

Referring now to the block type of fixed, the fixed type consists of values at 1, 2, 4, 8, 12, 16, or 32 bits, as indicated by the schema number. Continuing, the prediction block type consists first of a data block of prediction bits, one for each pixel. For a schema with a prediction bit size of one, the bit indicates the pixel is the same as the previous pixel. For two bits, the schema indicates to use the left, top, diagonal, or no prediction. The actual values follow the prediction bits, using the number of colors indicated by schema number: 2, 4, 8, 12, 16, 24, or 32 bits.

Referring to the hierarchical block type, this block type indicates that a block is to be divided into four equal blocks. The hierarchical type encodes each block in a recursive manner. Ideally, the blocks header repeats as well as all method with their block types, options, and schema. In one embodiment, only 4×4 from 8×8 is supported. The sub-blocks support a limited subset of methods. HR sub-schema are enumerated in the following manner. Packed: 2,4,8, or 16-bit color; Run: {2, 2}, {2, 6}, {2, 14}, {4, 4}, {4, 12}; Predict: 2, 4, 8, 16 bit color; Adaptive, Null 16-bit, Null all zero.

In the adaptive block type, data is encoded into a series of strips each having a byte header, which indicates the length and format of the strip. The available formats are a subset of Run, Null, and Fixed. The exact format is as follows. The header is six bits in length of strip followed by two bits, which indicates {4-bit fixed, 8-bit fixed, 16-bit fixed, or RUN}. If RUN is indicated, then another byte header with six bits for run and two bits for format may be run: {8, 8}, {8, 16}, {8, 24}, {8, 32}.

In the pattern block type, data is encoded as indexes to a string lookup table. This is planned for by the leaving of an open schema number, and each data is an index into a global table of strings. So to encode a particular block, a method is chosen by enumeration through possible block types, block schemas, and block options. A high-level algorithm is used herein to describe the strategy. In this regard, the high-level algorithm may be described by the following pseudo-code. This operation uses byte aligned methods for speed and finding a best fit which typically outperforms a generalized solution.

The encoder outputs the frame header, containing global parameters such as resolution, timestamp, and the like. Additionally, the output global table contains unique colors at minimal number of bits. For each N×N block, the encoder (1) encodes each block by enumerated block options, types and schema; and (2) outputs the header and the block data that uses the method deemed smallest/fastest for decoder in a byte aligned fashion. Further, the encoder outputs the index of each block of that starts a scan-line in the compressed stream.

In one embodiment, the encoder may encode all possible combinations and use the smallest one. A heuristic may then be applied to use a slightly larger method if it is considerably faster for the decoder. The encoding of the blocks is optimized by using the number of unique colors in the block and the current size of the best encoding method. The blocks are encoded by converting the input to the block-type format. For example, a run block-type converts a run of 255, 255, and 255 to {3, 255}. An encoder is basically a group of simple conversions. The adaptive and pattern types are more complex since they may be done in a variety of ways. For these types, the algorithm chooses the greedy approach. For adaptive types, the algorithm always continues a run, if possible. For pattern types, the algorithm finds the longest match, next longest match, and so on.

Referring now to the frame header, as the high-level algorithm states, the first step is to output the header, the first of which is a sequence header:

| Bits | Field |
|---|---|
| 32 | Constant “iris” |
| 32 | Version of encoder |
| 32 | Constant (0x30) |
| 16 | Image Width |
| 16 | Image Height |
| 8 | Bits per pixel |
| 32 | Microseconds per frame |
| 32 | Number of Frames in Sequence |

Each frame is preceded by a frame header, which has the following format:

| Bits | Field |
|---|---|
| 8 | Constant (0x41) |
| 32 | Frame Size in Bytes, including header |
| 32 | Time stamp in milliseconds |
| 8 | 1 = Key Frame, 2 = Delta Frame |
| 24 | Size of Global Palette |

As briefly described above, in one embodiment of the Iris video codec engine system, the lossy mode performs a few custom filters on the input image before encoding it. This pre-processing enables the decoder code to remain unchanged while enhancing the compression ratios. All filters have an adjustable cap for the maximal distortion allowed (default 0.5%), i.e., variation from the original image.

A “sieve” filter is applied by the system that compares each pixel (x,y) with the previous frame's pixel (x,y). If the pixels are determined to be “close enough,” the filter copies the previous pixel to the current pixel. The threshold is set very low to maintain quality. The intent is to create more “same as previous block” cases, which are extremely fast to process.

Additionally, the system applies a color reduction filter that reduces the number of unique pixels in the image. The colors are mapped to “bins” by masking off the lower two bits of each R, G, B, A component. The least frequent bins have their colors chosen by a weighted average (by frequency) of the actual colors that belong to the bin.

Next, the system builds a global palette by finding each unique pixel in the image. The pixel data in the compressed image always refers to the global palette unless the block header specifically states otherwise. The pixel entries are sorted by frequency. The sorting allows palette entry with lower bit requirements to occur more frequently, e.g., one is smaller than 1024.

A single byte prefixes the palette to indicate its format. The data may be raw, in which the bits per palette entry match the “bits per pixel” of the sequence header. The data may “differentially mapped,” which is a format of a bit per palette entry plus palette data. If the bit is one, then the entry is raw, otherwise the data is an index into the previous palette's table. The bit map is optionally run-length encoded.

In an embodiment of the Iris video codec engine system, the code is to be implemented as well optimized. The packed or “FixLen” packets, with packed bits, may be decoded fast by using an index to array. For example, to convert 8 bits to 8 bytes can be done by an index to the 256 entry array, since items are byte-aligned. Additionally, SSE/MMX instructions to SHIFT or AND can be done 8 items at a time. Furthermore, inverted data may be performed fast with an array LUT, commonly known as a “ZigZag” array. Type-casting 4 bytes to an integer is much faster than shifting/masking. Data values that are 16, 24, 32 bit should be stored in little-endian format.

In one embodiment of the Iris video codec engine system, Iris 32 bit lossy is the recommended format. Other formats may also be implemented in other embodiments. The quality of images are roughly 3.0% degraded for BINK, 2.0% for Iris 16 bit, 0.5% for Iris lossy32 bit, and the MNG and Iris L32 are lossless. Speed favors the Iris video codec engine system by approximately eight times over MNG and three times over BINK.

Specifically, by utilizing one preferred embodiment of the Iris video codec engine system, the following capabilities are realized over BINK codec: (1) partial decoding is fully supported; (2) a hardware processing is possible; (3) Alpha blending may be integrated; (4) efficiently runs and effectively compresses “cartoonish” content; (5) supports both lossless and lossy modes; and (6) requires about a quarter of the CPU usage of BINK.

By utilizing one preferred embodiment of the Iris video codec engine system, the following capabilities are realized over Alpha RLE: (1) compresses at a rate five times as well, on average; (2) runs at approximately the same speed; (3) fully supports 24/32-bit color; and (4) does not increase boot time. Additionally, since most legacy games use the Alpha RLE format, boot time is drastically decreased.

Generally, by utilizing a preferred embodiment of the Iris video codec engine system, the following capabilities are realized: (1) compresses approximately twice as well as MNG; (2) runs at approximately the same speed as the Alpha RLE format (3) compresses losslessly (unlike BINK, which introduces small artifacts); (4) configured specifically for the “cartoonish” environment is gaming. (5) runs about four times as fast, although it does not compress to as low a bit-rate as BINK. Additionally, the Iris video codec engine system is able to compensate for the fact that the gaming environment does not place a premium on how long a file takes to encode. Standardized codecs cannot make these types of assumptions.

For stills, data is as follows: Splash (1660K to 717K), Pays (1425K to 472K), Stump (102K to 45K), Young (123K to 54K) aPizzaOpen (1326K to 709K), Adoorsopen (958K to 475K). For movies, the data is as follows:

Door Open:

| Method | Size |
|---|---|
| BINK | 2.01 KB |
| MNG | 6.70 KB |
| Iris 16 bit | 4.64 KB |
| Iris 32 bit lossy | 6.45 KB |
| Iris 32 bit lossless | 19.81 KB |

Bear:

| Method | Size |
|---|---|
| BINK | 2.97 KB |
| MNG | 10.90 KB |
| Iris 16 bit | 6.37 KB |
| Iris 32 bit lossy | 8.50 KB |
| Iris 32 bit lossless | 15.80 KB |

Nemo:

| Method | Size |
|---|---|
| BINK | 3.2 KB |
| MNG | 11.8 KB |
| Iris 16 bit | 8.16 KB |
| Iris 32 bit lossy | 9.12 KB |
| Iris 32 bit lossless | 18.1 KB |

Pizza:

| Method | Size |
|---|---|
| BINK | 2.91 KB |
| MNG | 13.10 KB |
| Iris 16 bit | 4.89 KB |
| Iris 32 bit lossy | 6.87 KB |
| Iris 32 bit lossless | 20.73 KB |

Toy Story:

| Method | Size |
|---|---|
| BINK | 4.20 KB |
| MNG | 15.28 KB |
| Iris 16 bit | 8.03 KB |
| Iris 32 bit lossy | 6.69 KB |
| Iris 32 bit lossless | 17.90 KB |

Free Game:

| Method | Size |
|---|---|
| BINK | 2.01 KB |
| MNG | 14.25 KB |
| Iris 16 bit | 2.97 KB |
| Iris 32 bit lossy | 4.96 KB |
| Iris 32 bit lossless | 8.13 KB |

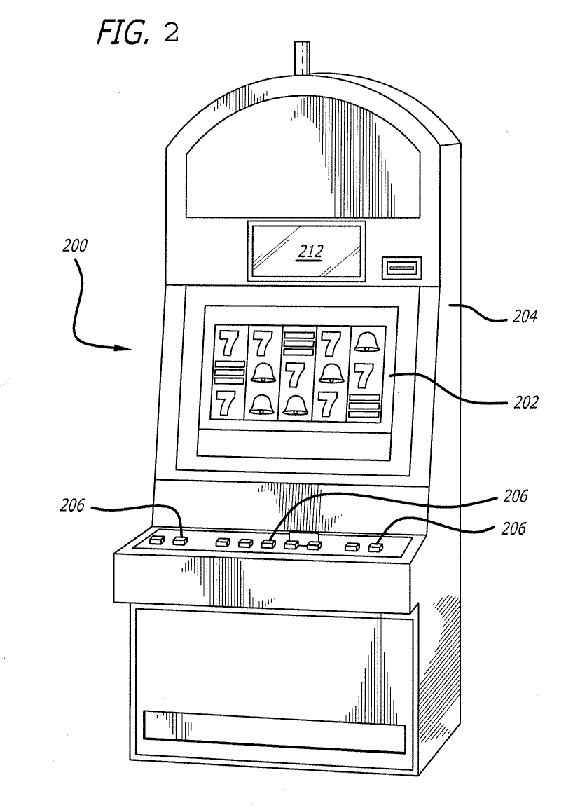

FIG. 2 illustrates one embodiment of a gaming device including the secured module for validating the BIOS. Turning to FIG. 2, the main cabinet 204 of the gaming machine 200 is a self-standing unit that is generally rectangular in shape. In another embodiment, the main cabinet 204 may be a slant-top gaming cabinet. Alternatively, in other embodiments, the gaming cabinet may be any shaped cabinet known or developed in the art that may include a top box. Additionally, the cabinet may be manufactured with reinforced steel or other rigid materials that are resistant to tampering and vandalism. Optionally, in an alternate embodiment, the gaming machine 200 may instead be a cinema-style gaming machine (not shown) having a widescreen display, as disclosed in U.S. application Ser. No. 11/225,827, entitled “Ergonomic Gaming Cabinet,” filed on Sep. 12, 2005, which is hereby incorporated by reference.

As shown in FIG. 2, the gaming machine 200 includes a main display 202. According to one embodiment, the main display 202 is a plurality of mechanical reels for presenting a slot-style game. Alternatively, the main display 202 is a video display for presenting one or more games such as, but not limited to, mechanical slots, video slots, video keno, video poker, video blackjack, video roulette, Class II bingo, games of skill, games of chance involving some player skill, or any combination thereof.

According to one embodiment, the main display 202 is a widescreen display (e.g., 16:9 or 16:10 aspect ratio display). In one embodiment, the display 202 is a flat panel display including by way of example only, and not by way of limitation, liquid crystal, plasma, electroluminescent, vacuum fluorescent, field emission, LCOS (liquid crystal on silicon), and SXRD (Silicon Xtal Reflective display), or any other type of panel display known or developed in the art. These flat panel displays may use panel technologies to provide digital quality images including by way of example only, and not by way of limitation, EDTV, HDTV, or DLP (Digital Light Processing).

According to one embodiment, the widescreen display 202 may be mounted in the gaming cabinet 204 in a portrait or landscape orientation. In another embodiment, the game display 202 may also include a touch screen or touch glass system (not shown). The touch screen system allows a player to input choices without using any electromechanical buttons 206. Alternatively, the touch screen system may be a supplement to the electromechanical buttons 206.

The main cabinet 204 of the gaming machine also houses a game management unit (not shown) that includes a CPU, circuitry, and software for receiving signals from the player-activated buttons 206 and a handle (not shown), operating the games, and transmitting signals to the respective game display 206 and speakers (not shown). Additionally, the gaming machine includes an operating system such as Bally Gaming's Alpha 05, as disclosed in U.S. Pat. No. 7,278,068, which is hereby incorporated by reference.

In various embodiments, a game program may be stored in a memory (not shown) comprising a read-only memory (ROM), volatile or non-volatile random access memory (RAM), a hard drive or flash memory device or any of several alternative types of single or multiple memory devices or structures.

As shown in FIG. 2, the gaming machine 200 includes a plurality of player-activated buttons 206. These buttons 206 may be used for various functions such as, but not limited to, selecting a wager denomination, selecting a number of games to be played, selecting the wager amount per game, initiating a game, or cashing out money from the gaming machine 200. The buttons 206 function as input mechanisms and may include mechanical buttons, electromechanical buttons or touch-screen buttons. In another embodiment, one input mechanism is a universal button module that provides a dynamic button system adaptable for use with various games, as disclosed in U.S. application Ser. No. 11/106,212, entitled “Universal Button Module,” filed Apr. 14, 2005 and U.S. application Ser. No. 11/223,364, entitled “Universal Button Module,” filed Sep. 9, 2005, which are both hereby incorporated by reference. Additionally, other input devices, such as but not limited to, touch pad, track ball, mouse, switches, and toggle switches, are included with the gaming machine to also accept player input. Optionally, a handle (not shown) may be “pulled” by a player to initiate a slots-based game.

One of ordinary skill in the art will appreciate that not all gaming devices will have all these components or may have other components in addition to, or in lieu of, those components mentioned here. Furthermore, while these components are viewed and described separately, various components may be integrated into a single unit in some embodiments.

In some embodiments, the gaming machine 200 is part of a gaming system connected to or with other gaming machines as well as other components such as, but not limited to, a Systems Management Server (SMS) and a loyalty club system (e.g., casino management personnel/system (CMP/CMS)). Typically, the CMS/CMP system performs casino player tracking and collects regular casino floor and player activity data. The gaming system may communicate and/or transfer data between or from the gaming machines 200 and other components (e.g., servers, databases, verification/authentication systems, and/or third party systems).

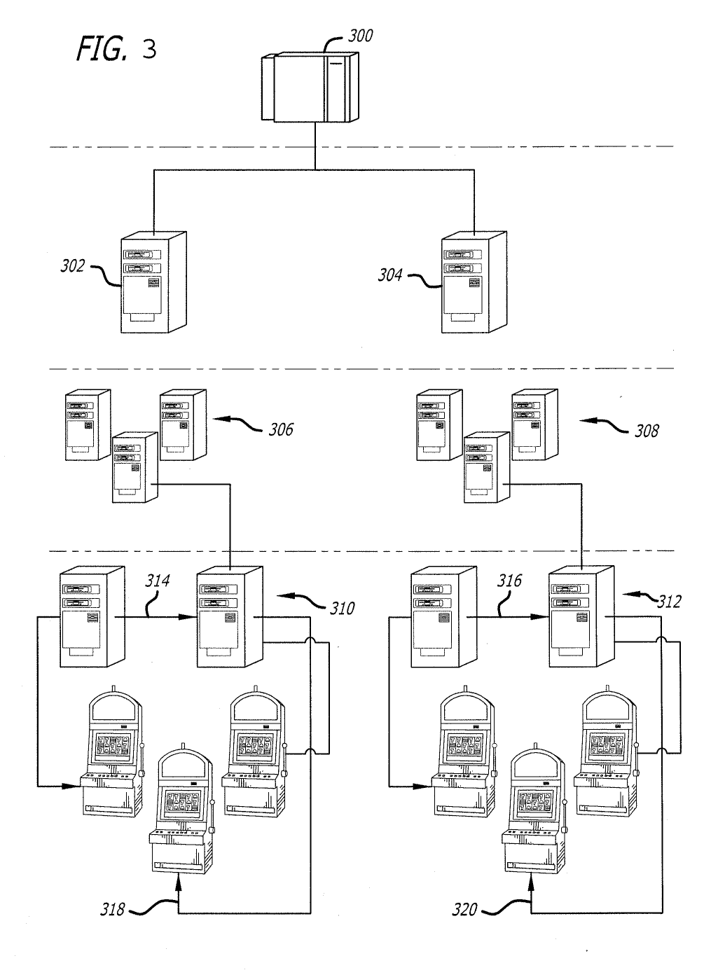

An embodiment of a network that may be used with the system is illustrated in FIG. 3. The example network consists of a top-level vender distribution point 300 that contains all packages for all jurisdictions, one or more Jurisdiction distribution points 302 and 304 that contain regulator-approved production signed packages used within that jurisdiction or sub-jurisdiction, one or more Software Management Points 306 and 308 to schedule and control the downloading of packages to the gaming machine, and a one or more Software Distribution Points 310 and 312 that contain regulator approved production signed packages only used in the gaming establishment that it supports. The Software Distribution Points (SDPs) 310 and 312 can communicate with Systems Management Points (SMPs) 314 and 316, respectively as well as directly to one or more gaming machines 318 and 320. The system allows for rapid and secure distribution of new games, configurations, and OS's from a centralized point. It makes it possible to update and modify existing gaming machines with fixes and updates to programs as well as providing modifications to such files as screen images, video, sound, pay tables and other gaming machine control and support files. It provides complete control of gaming machines from a centralized control and distribution point and can minimize the need and delay of human intervention at the gaming machine. In one embodiment, the configuration control may be from the SDPs 101 or 104 or from the gaming servers 103.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A video codec engine system for a gaming machine, the system comprising:
an encoder and decoder system for encoding and decoding video and still images, wherein the encoder and decoder system breaks up an image into spatial blocks, choosing an encoding type for each block from a list of possible encoding schemas, wherein the schemas are individually designed such that decoding procedures are a series of repetitive operations on byte-aligned symbols in a fixed length data stream; and
a partial decoding component, wherein the partial decoding component supports decoding a sub-rectangle of a given frame;
wherein the video codec engine system enables a seek function that advances in stream without decoding all frames in-between a beginning seek frame and an ending seek frame;
wherein the video codec engine system enables alpha blending of its output buffer with an output from another buffer; and
wherein the system supports both still frames and video.

2. The system of claim 1, wherein the system is configured to construct low-bitrate streams that facilitate fast decoder code.

3. The system of claim 1, wherein the system provides low-bitrate streams, while the repetitive, byte-aligned, fixed length nature of the stream provides speed.

4. The system of claim 1, wherein the system includes a list of possible encoding schema for each spatial block with schemas that specifically target byte-aligned methods.

5. The system of claim 1, wherein the system employs lossy video as a pre-filter to encoding only, while decoder code is the same for lossless and lossy video.

6. The system of claim 1, wherein the system employs pixel correlation such that the system breaks images into N by N blocks when compressing patterns to take advantage of spatial redundancy.

7. The system of claim 1, wherein the system enables null block types.

8. The system of claim 1, wherein the system enables run block types.

9. The system of claim 1, wherein the system enables fixed block types.

10. The system of claim 1, wherein the system enables prediction block types.

11. The system of claim 1, wherein the system enables hierarchical block types.

12. The system of claim 1, wherein the system enables adaptive block types.

13. The system of claim 1, wherein the system enables pattern block types.

14. A video codec engine system for a gaming machine, the system comprising:
an encoder and decoder system for encoding and decoding video and still images, wherein the encoder and decoder system breaks up an image into spatial blocks, choosing an encoding type for each block from a list of possible encoding schemas, wherein the schemas are individually designed such that decoding procedures are a series of repetitive operations on byte-aligned symbols in a fixed length data stream; and
a partial decoding component, wherein the partial decoding component supports decoding a sub-rectangle of a given frame;
wherein the video codec engine system enables alpha blending of its output buffer with an output from another buffer.

15. A video codec engine method for a gaming machine, the method comprising:
encoding and decoding video and still images by breaking up an image into spatial blocks;
choosing an encoding type for each block from a list of possible encoding schemas, wherein the schemas are individually designed such that decoding procedures are a series of repetitive operations on byte-aligned symbols in a fixed length data stream;
decoding a sub-rectangle of a given frame using a partial decoding component; and
alpha blending of an output buffer with an output from another buffer.
